(19) United States
(12) Patent Application Publication
(10) Pub. No.: US 2024/0298061 A1
(43) Pub. Date: Sep. 5, 2024

(54) METHOD, APPARATUS, ELECTRONIC DEVICE AND STORAGE MEDIUM FOR DISPLAYING PROMPT INFORMATION

(71) Applicant: Beijing Bytedance Network Technology Co., Ltd., Beijing (CN)

(72) Inventors: Yuanyuan WANG, Beijing (CN); Yanhao SHEN, Beijing (CN); Qi ZHAO, Beijing (CN)

(21) Appl. No.: 18/291,736

(22) PCT Filed: Oct. 18, 2022
(86) PCT No.: PCT/CN2022/125841

§ 371 Date: Jan. 24, 2024

(30) Foreign Application Priority Data
Oct. 22, 2021 (CN) 202111235458.1

(51) Int. Cl. H04N 21/431; H04N 21/2187

(52) U.S. Cl. CPC H04N 21/4312; H04N 21/2187

(57) ABSTRACT

The disclosure discloses a method, apparatus, electronic device and storage medium for displaying prompt information. According to the method, in response to detecting a to-be-displayed prompt content associated with a current live stream content is pre-stored on a resource server, a prompt content request entrance is displayed on a current live stream interface. In response to a trigger instruction of the prompt content request entrance, the to-be-displayed prompt content is requested to the resource server. A view layer is overlaid on the current live stream interface and the to-be-displayed prompt content is displayed, where the to-be-displayed prompt content is a non-livestream traffic pushing content.

The present application claims priority to Chinese Patent Application No. 202111235458.1 filed on Oct. 22, 2021, the entirety of which is incorporated herein by reference.

### FIELD

The present disclosure relates to the technical field of live stream, for example, to a method, apparatus, electronic device, and storage medium for displaying prompt information.

### BACKGROUND

With the development of Internet technology, more and more business forms can be shown in the live stream, comprising games, goods sales, and knowledge popularization. In order to make the live stream content rich and smooth, or browse some information related to the live content during the process of live streaming, additional content display boards are usually set up to prompt and supplement the relevant content.

However, by setting up additional content board, the live streamer's eyes need to repeatedly switch between the live stream screen area and the content board, which will affect the live stream state. If the mode of display content is configured in advance in the live streamer client, as a number of live streamers in the live stream need to prompt the display of different content, it is necessary to frequently update the live stream client application version, increasing the development cost of the content prompting function, and the degree of implementation is not high.

### SUMMARY

The embodiments of the present disclosure provide a method, apparatus, electronic device and storage medium for displaying prompt information, which can directly display live stream-related prompt content on a live stream interface so that the live streamer user can conveniently and directly obtain content prompt information related to live stream during the live stream process, have a better live stream experience, and at the same time, reduce the cost of development of the live stream interface prompt information display function.

In a first aspect, embodiments of the present disclosure provide a method for displaying prompt information. According to the method, in response to detecting a to-be-displayed prompt content associated with a current live stream content is pre-stored on a resource server, a prompt content request entrance is displayed on a current live stream interface. In response to a trigger instruction of the prompt content request entrance, the to-be-displayed prompt content is requested to the resource server. A view layer is overlaid a on the current live stream interface and the to-be-displayed prompt content is displayed, wherein the to-be-displayed prompt content is a non-livestream traffic pushing content.

In a second aspect, embodiments of the present disclosure further provide an apparatus for displaying prompt information. The apparatus for displaying prompt information comprises a prompt content prompt module, a prompt content request module, a prompt content display module. The prompt content prompt module is configured for, in response to detecting a to-be-displayed prompt content associated with a current live stream content is pre-stored on a resource server, displaying a prompt content request entrance on a current live stream interface. The prompt content request module is configured for, in response to a trigger instruction of the prompt content request entrance, requesting the to-be-displayed prompt content from the resource server. The prompt content display module is configured for overlaying a view layer on the current live stream interface and displaying the to-be-displayed prompt content, wherein the to-be-displayed prompt content is a non-livestream traffic pushing content.

In a third aspect, embodiments of the present disclosure further provide an electronic device. The electronic device comprises one or more processors and a storage unit configured for storing one or more programs. The one or more programs, when executed by the one or more processors, cause the one or more processors to implement a method for displaying prompt information according to any of embodiments of the present disclosure.

In a fourth aspect, embodiments of the present disclosure further provide a storage medium comprising computer-executable instruction. The computer-executable instructions, when executed by a computer processor, are configured for performing a method for displaying prompt information according to any of embodiments of the present disclosure.

### BRIEF DESCRIPTION OF THE DRAWINGS

Throughout the accompanying drawings, the same or similar reference numerals represent the same or similar elements. It should be understood that the accompanying drawings are schematic, and the originals and elements are not necessarily drawn to scale.

FIG. 1 is a schematic flow chart of a method for displaying prompt information provided by an embodiment of the present disclosure;

FIG. 2 is a schematic diagram of a live stream interface provided by an embodiment of the present disclosure;

FIG. 3 is a schematic diagram of an effect for displaying prompt information provided by an embodiment of the present disclosure;

FIG. 4 is a schematic flow chart of a method for displaying prompt information provided by another embodiment of the present disclosure;

FIG. 5 is a schematic diagram of a live stream interface guidance video request entrance provided by an embodiment of the present disclosure;

FIG. 6 is a schematic diagram of a guidance video display interface provided by an embodiment of the present disclosure;

FIG. 7 is a structural schematic diagram of an apparatus for displaying prompt information provided by an embodiment of the present disclosure; and

FIG. 8 is a structural schematic diagram of an electronic device provided by an embodiment of the present disclosure.

### DETAILED DESCRIPTION

It should be understood that multiple steps described in the method implementation of the present disclosure can be performed in different orders and/or in parallel. In addition, the method implementation can comprise additional steps and/or omit the steps shown. The scope of the present disclosure is not limited in this regard.

The term “comprise” and its variations used herein are open-ended, i.e. “comprise but not limited to”. The term “based on” is “at least partially based on”. The term “one embodiment” represents “at least one embodiment”; the term “another embodiment” represents “at least one additional embodiment”; and the term “some embodiments” represents “at least some embodiments”. Related definitions of other terms will be given in the following description.

It should be noted that the concepts of “first” and “second” mentioned in the present disclosure are only used to distinguish different apparatuses, modules, or units, and are not used to limit the order or interdependence of the functions performed by these apparatuses, modules, or units.

It should be noted that the modifications of “one” and “multiple” mentioned in the present disclosure are illustrative but not restrictive. Those skilled in the art should understand that unless otherwise specified in the context, they should be understood as “one or more”.

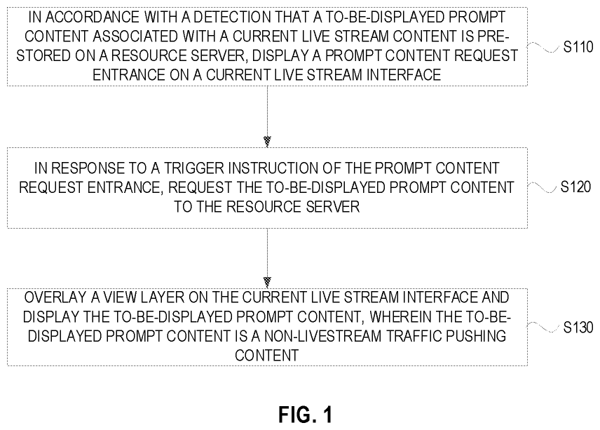

FIG. 1 is a schematic flow chart of a method for displaying prompt information provided by an embodiment of the present disclosure. Embodiments of the present disclosure are applicable to a situation where, during a live stream, a live streamer displays a prompt information in his/her client interface and the prompt information is not synchronously displayed to an audience watching the live stream. The method may be performed by an apparatus for displaying prompt information, which may be implemented in the form of software and/or hardware, and which may be configured in an electronic device, such as in a mobile terminal or a server device.

As shown in FIG. 1, the present embodiment provides a method for displaying prompt information comprises the following steps.

At S110, in accordance with a detection that a to-be-displayed prompt content associated with a current live stream content is pre-stored on a resource server, an electronic device displays a prompt content request entrance on a current live stream interface.

The prompt content is the information content associated with a current live stream user or a current live stream content of a live stream room, for example, an outline of a live stream script, a video clip in a live stream, a game, or relevant prompt content of the relevant connecting personnel and other information.

For example, the prompt content may be a content that is pre-produced by the live stream user and uploaded to a predetermined resource server based on the requirements of the live stream content. The prompt content is correspondingly set with at least one of the corresponding live user information, live stream room information, live stream time, or the subject of the prompt content, which can be used as identifier information. For some general business content information, it can also be uploaded to the predetermined resource server by the business requirement provider. Such information has identifier that matches with the relevant business settings, for example, interactive games during the process of live streaming and the corresponding game prompt information.

When a live streamer user logs in to a live stream account or enters a live stream room, if there is a prompt content associated with the current live stream pre-stored on the predetermined resource server, the prompt content request entrance will be displayed on the current live stream room interface as a prompt content for the live stream person.

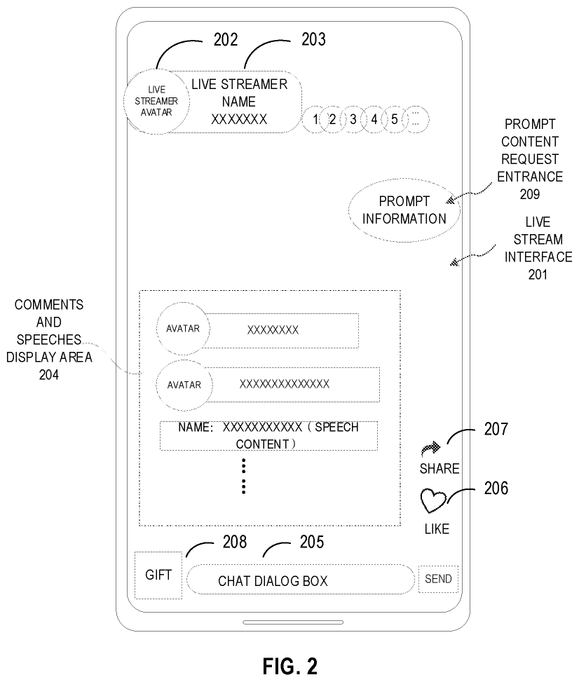

Exemplarily, the prompt content request entrance of the live stream interface is shown in the schematic diagram of the live stream interface 201 in FIG. 2. In the live stream interface 201, a live streamer avatar 202 and a live streamer name 203 are displayed, and the identifier of the live stream room and the number of online viewers of the live stream room can be displayed below the live streamer name. Numbers 1-5 represent the avatars of some of the viewers in the live stream room, and by triggering the ellipsis after Number 5, all of the viewers in the live stream room can be displayed. In the live stream interface 201, the comments and speeches display area 204 of the audience is further comprised, as a real-time interaction display area between the audience and the live streamer. In addition, chat dialog boxes 205, likes 206, shares 207, gifts 208, and other functional controls are further comprised. In FIG. 2, a prompt content request entrance 209 is exemplarily provided on the right side of the live stream interface 201. The prompt content request entrance 209 can be placed in any position in the live stream interface 201 that is convenient for operation and does not affect the viewing position of the interface. The live streamer user can trigger the prompt content request entrance 209 to request a corresponding prompt content from the predetermined resource server.

At S120, in response to a trigger instruction of the prompt content request entrance, the electronic device requests the to-be-displayed prompt content from the resource server.

The prompt content request entrance is an instruction issued by the user of the live stream client through the request entrance of the prompt content before the live stream starts or during the live stream. In accordance with a determination that the trigger of the prompt content request entrance is detected, the prompt content request instruction is obtained, and the corresponding prompt content is requested from a predetermined resource server based on the prompt content request instruction. For example, the predetermined resource server may select an effect resource server, and the prompt content is stored in the effect resource server in the form of an effect resource package. Herein, the effect resources refer to effect resources such as gifts and stickers in the live stream. The predetermined resource server may also be a specialized content prompt storage server.

For example, after requesting the to-be-displayed prompt content from the predetermined resource server, the corresponding to-be-displayed information can be obtained and stored in the predetermined data storage path. The predetermined storage path is used for storing non-livestream traffic pushing data content, i.e., the data content stored through the path will not affect the live stream data traffic pushing storage. Similar to an effect resource storage path that is only displayed in the live streamer client, the content stored through this path is only displayed in the live streamer client.

At S130, the electronic device overlays a view layer on the current live stream interface and displays the to-be-displayed prompt content, where the to-be-displayed prompt content is a non-livestream traffic pushing content.

For example, when displaying the to-be-displayed prompt content, a view layer, which may also be called a view interface, is re-invoked for display in the current live stream interface. The view layer can be a transparent view layer that is overlaid on the current live stream interface and will not obscure the live stream interface except for the position where the prompt content is to be displayed. The position of the prompt content can be set based on the position of the portrait in the live stream interface, and the position of multiple function controls and comment (pop-up) display area, so that the prompt content will not block the portrait and will not block the comment area of the live stream viewers, and other key content interfaces. The display form of the prompt content can also be diversified, comprising text, picture, and animated video, etc. The content can be displayed in the display form of the prompt content resource itself. Thus, the live streamer user can see the prompt content related to the live stream.

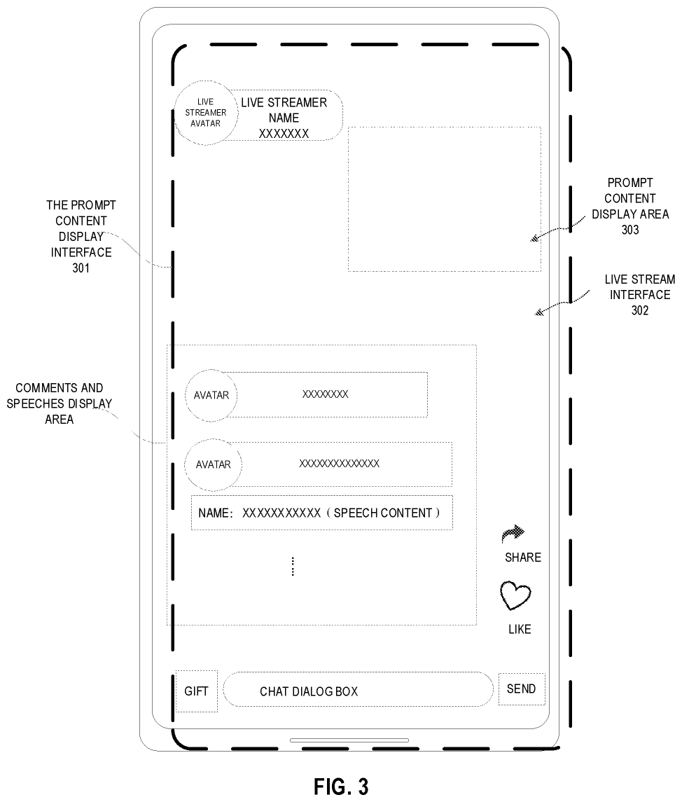

Exemplarily, the prompt content display interface may refer to the schematic diagram shown in FIG. 3. In FIG. 3, the black bold dashed border represents a view layer of the same size as the live stream interface 302. As the prompt content display interface 301, the black bold dashed border area is a view layer that overlaps with the live stream interface 302 and is shown in the schematic diagram in a staggered position with the live stream interface 302 in order to highlight the view layer. In the view layer, a prompt content display area 303 is included for displaying the prompt content.

Furthermore, in the prompt content display interface 301, the area other than the prompt content display area 303 is a transparent layer. Thereby, even after the prompt content display interface 301 is overlaid with the live stream interface 302, it will not affect the live streamer user's ability to watch the audience's real-time speeches, and information content such as gifts. Certainly, in FIG. 3, the position of the prompt content display area 303 is only for exemplary illustration and is not a fixed area position.

For example, before displaying the prompt content, at least one parameter of a display position, a display mode, a number of display times, a display duration, or a display effect of the to-be-displayed prompt content can be set. Herein, the display position can be the upper right corner of the view interface, the lower part of the view interface, etc.; the display mode comprises text scrolling play, automatic page turning, picture switching mode and frequency, video play speed, and other parameter settings; the number of display times comprises the number of times the picture is displayed and the number of times the video is played; the display duration can be 10 minutes, or perform prompt content display throughout the live stream and any other settable duration; the display effect can be the display effect of the prompt content, such as the content display area color change, the display content text size change, and video effects. All of the above parameters can be configured with personalized parameters. If no parameter settings are made, all the above parameters are default values.

The technical solution of the embodiment of the present disclosure may send a prompt to the user by displaying the prompt content request entrance in the current live stream interface when detecting a to-be-displayed prompt content associated with a current live stream content pre-stored on a resource server, informing the user that the prompt content associated with the live stream content can be obtained; if the user triggers the prompt content request entrance, in response to a trigger instruction of the prompt content request entrance, request the to-be-displayed prompt content from the resource server; finally, loading and overlaying a view layer on the current live stream interface and displaying the to-be-displayed prompt content can display the prompt content that the user requires to display without affecting the live stream user's viewing of the live stream interface, the prompt content is also not be traffic-pushed to the client viewing the live stream for display. In addition, the parameters of the display duration, the number of display times, the display mode, and the display effect of the prompt content can be set in a personalized manner. The technical solution of the embodiments of the present disclosure avoids the situation in which prompt content cannot be directly displayed through the live stream interface in the related technology, and can directly display prompt content related to the live stream in the live stream interface, causing the live streamer user in the live stream process to conveniently and directly obtain prompt information related to the live stream, and have a better live streaming experience, and at the same time, reduces the cost of development of the prompt information display function of the live stream interface.

Embodiments of the present disclosure may be combined with a plurality of example embodiments of the method for displaying prompt information provided in the above embodiments. The method for displaying prompt information provided in the present embodiments describes a process in which a live streamer plays a game guidance animation during the process of live streaming.

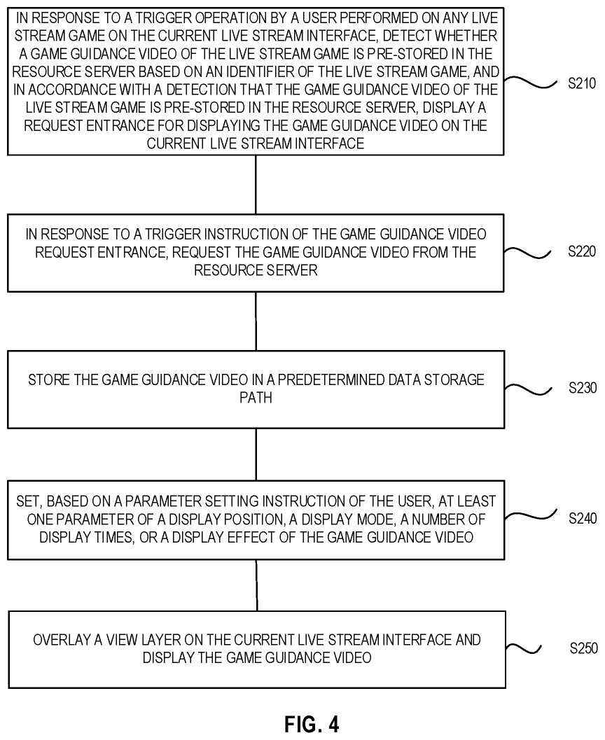

FIG. 4 is a schematic flow chart of a method for displaying prompt information provided by another embodiment of the present disclosure. As shown in FIG. 4, the method for displaying prompt information provided by the present embodiment comprises the following steps.

At S210, in response to a trigger operation by a user performed on any live stream game on the current live stream interface, an electronic device detects whether a game guidance video of the live stream game is pre-stored in the resource server based on an identifier of the live stream game. In accordance with a detection that the game guidance video of the live stream game is pre-stored in the resource server, the electronic device displays a request entrance for displaying the game guidance video on the current live stream interface.

Currently, in multiple live stream platforms, there are many live streamers perform live streams every day, and when the live stream duration is too long, in order to prevent the audience from feeling bored and to enhance the interestingness of the live stream content, many live streamers will add live stream mini-games in the live stream. By participating in the mini-game together with the live streamer user and the audience user, the participation of the audience user is enhanced, and the viewability of the live stream is strengthened. Due to the current varied types of mini-games, in order to allow the live streamer to quickly understand the game, it is possible to adopt a visualized guidance mode in order to facilitate the live streamer to quickly understand the game. In other words, presenting a visualized game guidance video on the guidance page in the live stream in a way that shows the live streamer user the game guidance page, thus helping the live streamer to quickly understand the game, reducing the cost of understanding for the live streamer, and enhancing the ease of use of the mini-games in the live stream.

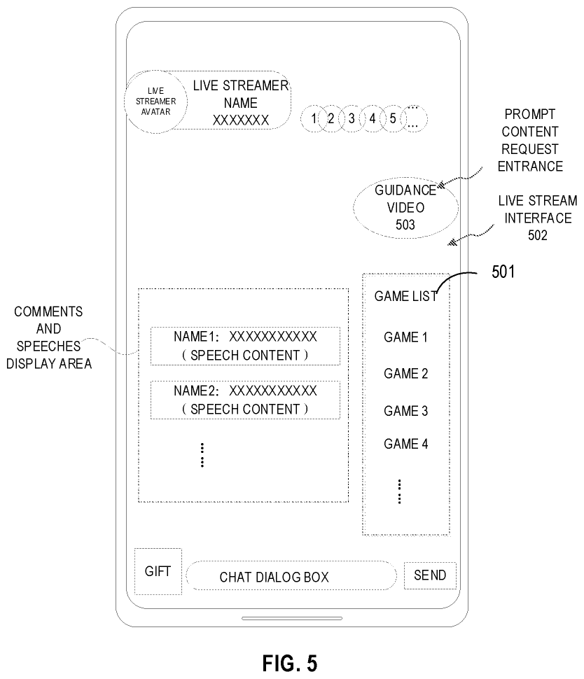

When a live stream user intends to play a game by him or herself or interact with the audience through a game, he or she can select a target game in a game list 501, and the live stream client can obtain the user's selection instructions for the live stream game, thus in response to the user's selection instructions for the live stream game, displaying in the current live stream interface 502 a guidance video request entrance for the target game corresponding to the selection instructions, as shown in FIG. 5. Through this game guidance video request entrance, the live streamer user can be informed that he/she can get the game rules guidance video 503 of the target game by triggering the game guidance video request entrance. Certainly, if the game guidance is not required, the game guidance video request entrance can be ignored, and the game can be entered directly. Herein, the target game is the game selected by the live stream user in the game category table, after the user selects the target game, it will jump to display the target game interface and display the prompt content request entrance of the game guidance video 503, and the game list 501 is no longer displayed.

At S220, in response to a trigger instruction of the game guidance video request entrance, the electronic device requests the game guidance video from the resource server.

For example, the prompt content request instruction includes an identifier of the requested content object, for example, an identifier such as a number or a name of the target game, based on which the to-be-obtained target game guidance video can be determined. Thus, after the user triggers the game guidance video request entrance, a responsive guidance video request trigger instruction is obtained, and based on the prompt content request instruction (i.e., the game guidance video request instruction), the corresponding guidance video of the target game is requested from the predetermined resource server and obtained.

At S230, the electronic device stores the game guidance video in a predetermined data storage path.

Herein, the predetermined data storage path is used for storing non-livestream traffic pushing data content.

At S240, the electronic device sets, based on a parameter setting instruction of the user, at least one parameter of: a display position, a display mode, a number of display times, or a display effect of the game guidance video.

Herein, the display position can be a play position of the guidance video in the view interface, such as the upper right corner of the view interface, the center of the view interface, or the part directly underneath the view interface, etc.; the display mode comprises parameters such as the video play speed, etc.; the number of display times comprise the number of times that the guidance video has been played, for example, it can be set to no longer play the video after playing the predetermined number of times because the live stream user has learned how to play the game and no longer needs to watch the guidance video; the display effect can be the display effects of the display content, such as the color change of the content display area and video effects, etc. The display effect can be the display of the content display effects, such as color change of the content display area and video effects. Certainly, when there is no requirement for the user to set the display parameters of the guidance video, the parameters can be personalized, and the default values can be adopted. In other words, after step S230, step S250 is directly performed to display the game guidance video.

At S250, the electronic device overlays a view layer on the current live stream interface and displays the game guidance video.

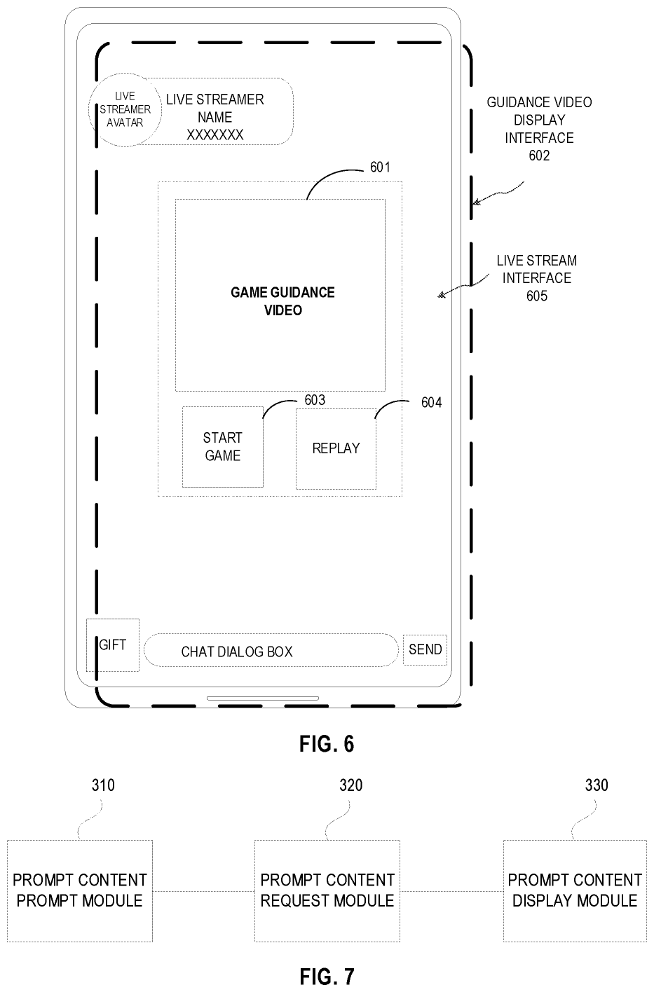

For example, the display interface of the game guidance video 601 may be an interface as shown in FIG. 6, where the black bolded dashed border represents a view layer of the same size as the live stream interface 605 as the game guidance video display interface 602, and the black bolded dashed border area is a view layer overlapping with the live stream interface 605, which is shown in the illustration diagram in a staggered display with the live stream interface 605 in order to highlight the view layer. In the view layer, a prompt content display area is included for displaying the prompt content. Moreover, in the prompt content display interface, the area other than the game guidance video display area is a transparent layer. Thereby, after the prompt content display interface is overlaid with the live stream interface 605, it will not affect the live streamer user's ability to watch the information content, such as real-time speeches of the audience, and gifts.

For example, an exit guidance video control (i.e., the start game control 603 in FIG. 6) and a replay control 604 can be further provided in the game guidance video display area. When the live streamer user clicks on the start game control 603, in response to the trigger operation for the start game control 603, the process of playing the guidance video can be ended and the formal game interface can be entered; alternatively, when the live streamer user clicks on the replay control 604, in response to the trigger operation for the replay control 604, the game guidance video can be played once again. For example, when entering the game interface, it is possible to enter the pre-game process such as playing the game entry music session while loading the game data, start the game after the game is fully loaded, and enter the game settlement interface after the game is finished. In turn, the game can be exited based on the operation of the live stream user to return to the live stream interface 605 or continue to play the game again.

In the technical solution of the embodiment of the present disclosure, when a user selects a target live stream game in the live stream process, by providing the user with a game guidance video request entrance, causing the user to obtain the game guidance video, and overlaying the view layer and displaying the game guidance video in the live stream interface, the user is able to conveniently and quickly understand the game, which facilitates the user's playing of the game during the live stream process, and makes the live stream process smoother. The technical solution of the embodiments of the present disclosure avoids the situation in which prompt content cannot be directly displayed through the live stream interface in the related technology, and can directly display prompt content related to the live stream in the live stream interface, causing the live streamer user in the live stream process to conveniently and directly obtain prompt information related to the live stream, and have a better live streaming experience, and at the same time, reduces the cost of development of the prompt information display function of the live stream interface.

FIG. 7 is a structural schematic diagram of an apparatus for displaying prompt information provided by embodiments of the present disclosure. The apparatus for displaying prompt information provided in the present embodiment is applicable to the live stream process, the live streamer displays prompt information on its client interface, and the prompt information is not displayed synchronously to the audience watching a live stream.

As shown in FIG. 7, the apparatus for displaying prompt information comprises a prompt content prompt module 310, a prompt content request module 320, and a prompt content display module 330.

The prompt content prompt module 310 is configured for, in accordance with a detection that a to-be-displayed prompt content associated with a current live stream content is pre-stored on a resource server, displaying a prompt content request entrance on a current live stream interface; the prompt content request module 320 is configured for, in response to a trigger instruction of the prompt content request entrance, requesting the to-be-displayed prompt content from the resource server; and the prompt content display module 330 is configured for overlaying a view layer on the current live stream interface and displaying the to-be-displayed prompt content, wherein the to-be-displayed prompt content is a non-livestream traffic pushing content.

Embodiments of the present disclosure of the technical solution send a prompt to the user by displaying the prompt content request entrance in the current live stream interface when detecting a to-be-displayed prompt content associated with a current live stream content pre-stored on a resource server, informing the user that the prompt content associated with the live stream content can be obtained; if the user triggers the prompt content request entrance, in response to a trigger instruction of the prompt content request entrance, request the to-be-displayed prompt content from the resource server; finally, loading and overlaying a view layer on the current live stream interface and displaying the to-be-displayed prompt content can display the prompt content that the user requires to display without affecting the live stream user's viewing of the live stream interface, the prompt content is also not be traffic-pushed to the client viewing the live stream for display. The technical solution of the embodiments of the present disclosure avoids the situation in which prompt content cannot be directly displayed through the live stream interface in the related technology, and can directly display prompt content related to the live stream in the live stream interface, causing the live streamer user in the live stream process to conveniently and directly obtain prompt information related to the live stream, and have a better live streaming experience, and at the same time, reduces the cost of development of the prompt information display function of the live stream interface.

For example, the apparatus for displaying prompt information further comprises a prompt content storage module. The prompt content storage module is configured for, after requesting the to-be-displayed prompt content from the resource server, storing the to-be-displayed prompt content in a predetermined non-livestream traffic pushing data storage path.

For example, the apparatus for displaying prompt information further comprises a display parameter setting module, configured for: before displaying the to-be-displayed prompt content, setting at least one parameter of a display position, a display mode, a number of display times, a display duration, or a display effect of the to-be-displayed prompt content.

For example, the prompt content display module 330 is configured for: displaying the to-be-displayed prompt content in a form of texts, pictures, or videos.

For example, the to-be-displayed prompt content is a guidance video of a live stream game. Correspondingly, the prompt content request module 310 can further be configured for: in response to a trigger operation by a user performed on any live stream game on the current live stream interface, detecting whether a game guidance video of the live stream game is pre-stored in the resource server based on an identifier of the live stream game; and in accordance with a detection that the game guidance video of the live stream game is pre-stored in the resource server, displaying a request entrance for displaying the game guidance video on the current live stream interface.

For example, the prompt content display module 330 can further be configured for: overlaying the view layer on the current live stream interface and playing the game guidance video.

For example, an exit guidance video control and a replay control are provided on an interface for displaying the game guidance video. The prompt content display module 330 can further be configured for, in response to a trigger operation for the exit guidance video control, ending a playing process of the game guidance video; or, in response to a trigger operation for the replay control, replaying the game guidance video.

The apparatus for displaying prompt information provided in the embodiments of the present disclosure can perform the method for displaying prompt information provided in any of the embodiments of the present disclosure and possesses the corresponding functional modules and beneficial effects of performing the method.

It is worth noting that the plurality of units and modules comprised in the above-described apparatus are only divided in accordance with functional logic, but are not limited to the above-described division, as long as they are capable of implementing the corresponding functions; furthermore, the specific names of the plurality of functional units are only for the purpose of facilitating mutual differentiation, and are not used to limit the scope of protection of the embodiments of the present disclosure.

Referring below to FIG. 8, a structural schematic diagram of an electronic device (e.g., a terminal device or a server in FIG. 8) 400 suitable for implementing embodiments of the present disclosure is illustrated. Terminal devices in embodiments of the present disclosure may comprise, but are not limited to, mobile terminals such as cell phones, laptop computers, digital broadcast receivers, PDAs (personal digital assistants), PADs (tablet computers), PMPs (portable multimedia players), in-vehicle terminals (e.g., in-vehicle navigation terminals), and the like, as well as fixed terminals such as digital TVs, desktop computers, and the like. The electronic device illustrated in FIG. 8 is merely an example and should not impose any limitation on the functions and scope of use of the embodiments of the present disclosure.

As shown in FIG. 8, the electronic device 400 may comprise a processing device (e.g., a central processor, a graphics processor, etc.) 401 that may perform multiple appropriate actions and processes based on a program stored in a Read-Only Memory (ROM) 402 or a program loaded from a storage device 408 into a Random Access Memory (RAM) 403. In the RAM 403, a plurality of programs and data required for operation of the electronic device 400 are also stored. The processing device 401, the ROM 402, and the RAM 403 are connected to each other through a bus 404. Input/output (I/O) interface 405 is also connected to bus 404.

Typically, the following devices may be connected to the I/O interface 405: an input device 406 comprising, for example, a touch screen, a touch pad, a keyboard, a mouse, a camera, a microphone, an accelerometer, a gyroscope, and the like; an output device 407 comprising, for example, a liquid crystal display (LCD), a loudspeaker, a vibrator, and the like; a storage device 408 comprising, for example, a magnetic tape, a hard disk, and the like; and a communication device 409. The communication device 409 may allow the electronic device 400 to communicate wirelessly or wiredly with other devices to exchange data. Although FIG. 8 illustrates electronic device 400 with multiple devices, it should be understood that it is not required to implement or have all of the illustrated devices. More or fewer devices may alternatively be implemented or possessed.

In particular, according to embodiments of the present disclosure, the process described above with reference to the flowchart may be implemented as a computer software program. For example, embodiments of the present disclosure comprise a computer program product comprising a computer program carried on a non-transitory computer-readable medium, the computer program including program code for performing the method shown in the flowchart. In such embodiments, the computer program may be downloaded and installed from a network via a communication device 409, or from a storage device 408, or from a ROM 402. When this computer program is executed by the processing device 401, the above-described functions defined in the method for displaying the prompt information of the embodiments of the present disclosure are performed.

The electronic device provided in the embodiments of the present disclosure belongs to the same disclosed idea as the method for displaying the prompting information provided in the above-described embodiments, and technical details not exhaustively described in the present embodiments can be found in the above-described embodiments, and the present embodiments have the same beneficial effects as the above-described embodiments.

Embodiments of the present disclosure provide a computer storage medium having a computer program stored thereon, the program, when executed by a processor, implementing the method of displaying prompt information provided in the above embodiments.

It should be noted that the computer-readable medium described above in the present disclosure may be a computer-readable signal medium or a computer-readable storage medium or any combination thereof. The computer-readable storage medium may be, but not limited to, for example, a system, or apparatus or appliance of electricity, magnetism, light, electromagnetism, infrared, or semiconductors, or an electrical connection of any one or more wires, or a combination of the above. More specific examples of computer-readable storage medium may comprise but are not limited to: an electrical connection having one or more wires, portable computer disk, hard disk, random access memory (RAM), read-only memory (ROM), erasable programmable read-only memory (EPROM, or flash memory), optical fiber, compact disc read-only memory (CD-ROM), optical storage device, magnetic storage device, or any suitable combination of the foregoing. For purposes of the present disclosure, a computer-readable storage medium may be any tangible medium that contains or stores a program that may be used by or in combination with an instruction execution system, apparatus, or component. And in the present disclosure, a computer-readable signal medium may comprise a data signal propagated in a baseband or as part of a carrier carrying computer-readable program code. Such propagated data signals may take a variety of forms, comprising electromagnetic signals, optical signals, or any suitable combination of the foregoing. The computer-readable signal medium may also be any computer-readable medium other than a computer-readable storage medium that sends, disseminates, or transmits a program for use by, or in conjunction with, an instruction-executing system, apparatus, or component. The program code contained on the computer-readable medium may be transmitted using any suitable medium, comprising: wire, fiber optic cable, radio frequency (RF), etc., or any suitable combination thereof.

In some implementations, clients, servers may communicate with any currently known or future developed network protocol such as HyperText Transfer Protocol (HTTP) and may be interconnected with any form or medium of digital data communication (e.g., a communications network). Examples of communication networks comprise Local Area Networks (LAN), Wide Area Networks (WAN), Internet (e.g., the Internet), and End-to-End Networks (e.g., ad hoc End-to-End Networks), as well as any currently known or future developed networks.

The computer-readable medium may be included in the above-mentioned electronic device; it may also exist separately and not be assembled into the electronic device.

The computer-readable medium carries one or more programs, the one or more programs, when executed by the electronic device, cause the electronic device to, in accordance with a detection that a to-be-displayed prompt content associated with a current live stream content is pre-stored on a resource server, display a prompt content request entrance on a current live stream interface; in response to a trigger instruction of the prompt content request entrance, request the to-be-displayed prompt content from the resource server; and overlay a view layer on the current live stream interface and displaying the to-be-displayed prompt content, where the to-be-displayed prompt content is a non-livestream traffic pushing content.

Computer program code for performing the operations of the present disclosure may be written in one or more programming languages or combinations thereof, and the programming languages comprise but are not limited to object-oriented programming languages, such as Java, Smalltalk, C++, and further comprises conventional procedural programming languages such as the “C” language, or similar programming languages. or similar programming languages. The program code may be executed entirely on the user's computer, partially on the user's computer, as a separate software package, partially on the user's computer and partially on a remote computer, or entirely on a remote computer or server. In the case of a remote computer, the remote computer may be connected to the user's computer over any kind of network, including a LAN or WAN, or it may be connected to an external computer (e.g., via an Internet connection using an Internet service provider).

The flowcharts and block diagrams in the accompanying drawings illustrate the architecture, functionality, and operation of systems, methods, and computer program products that may be implemented in accordance with various embodiments of the present disclosure. At this point, respective box in the flowcharts or block diagrams may represent a module, program segment, or portion of code that contains one or more executable instructions for implementing a specified logical function. It should also be noted that in some implementations that are determined to be substitutions, the functions indicated in the boxes may also occur in a different order than that indicated in the accompanying drawings. For example, two consecutively represented boxes may actually be executed substantially in parallel, and they may sometimes be executed in reverse order, depending on the function involved. It should also be noted that respective of the boxes in the block diagrams and/or flowcharts, as well as combinations of the boxes in the block diagrams and/or flowcharts, may be implemented in a dedicated hardware-based system that performs the specified function or operation, or may be implemented in a combination of dedicated hardware and computer instructions.

Units described as being involved in embodiments of the present disclosure may be implemented by way of software or may be implemented by way of hardware. Wherein the name of a unit does not in some cases constitute a limitation of the unit itself, for example, a first obtaining unit may also be described as “a unit for obtaining at least two Internet Protocol addresses”.

The functions described above herein may be performed, at least in part, by one or more hardware logic components. For example, exemplary types of hardware logic components that may be used include: Field Programmable Gate Array (FPGA), Application Specific Integrated Circuit (ASIC), Application Specific Standard Parts (ASSP), System on Chip (SOC), and System on Chip (SOC). Application Specific Standard Parts (ASSP), System on Chip (SOC), Complex Programmable Logic Device (CPLD) and so on.

In the context of the present disclosure, a machine-readable medium may be a tangible medium that may include or store a program for use by or in conjunction with an instruction execution system, device, or apparatus. The machine-readable medium may be a machine-readable signal medium or a machine-readable storage medium. The machine-readable medium may comprise an electronic, magnetic, optical, electromagnetic, infrared, or semiconductor system, device, or apparatus, or any suitable combination thereof. Machine-readable storage media may comprise an electrical connection According to one or more wires, a portable computer disk, a hard disk, a random-access memory (RAM), a read-only memory (ROM), an erasable programmable read-only memory (EPROM or flash memory), a fiber optic, a compact disk-read-only memory (CD-ROM) for convenience, an optical storage device, a magnetic storage device, or any suitable combination of the foregoing, or any suitable combination thereof.

According to one or more embodiments of the present disclosure, a method for displaying prompt information is provided. The method comprises: in accordance with a detection that a to-be-displayed prompt content associated with a current live stream content is pre-stored on a resource server, displaying a prompt content request entrance on a current live stream interface; in response to a trigger instruction of the prompt content request entrance, requesting the to-be-displayed prompt content from the resource server; and overlaying a view layer on the current live stream interface and displaying the to-be-displayed prompt content, wherein the to-be-displayed prompt content is a non-livestream traffic pushing content.

According to one or more embodiments of the present disclosure, the method further comprises, for example, after requesting the to-be-displayed prompt content from the resource server, storing the to-be-displayed prompt content in a predetermined non-livestream traffic pushing data storage path.

According to one or more embodiments of the present disclosure, the method further comprises, for example, before displaying the to-be-displayed prompt content, setting at least one parameter of a display position, a display mode, a number of display times, a display duration, or a display effect of the to-be-displayed prompt content.

According to one or more embodiments of the present disclosure, in the method for displaying prompt information, for example, displaying the to-be-displayed prompt content comprises: displaying the to-be-displayed prompt content in a form of texts, pictures, or videos.

According to one or more embodiments of the present disclosure, the method further comprises, for example, in accordance with a detection that a to-be-displayed prompt content associated with a current live stream content is pre-stored on a resource server, displaying a prompt content request entrance on a current live stream interface, comprising: in response to a trigger operation by a user performed on any live stream game on the current live stream interface, detecting whether a game guidance video of the live stream game is pre-stored in the resource server based on an identifier of the live stream game; and in accordance with a detection that the game guidance video of the live stream game is pre-stored in the resource server, displaying a request entrance for displaying the game guidance video on the current live stream interface.

According to one or more embodiments of the present disclosure, in the method for displaying prompt information, for example, overlaying a view layer on the current live stream interface and displaying the to-be-displayed prompt content comprises: overlaying the view layer on the current live stream interface and playing the game guidance video.

According to one or more embodiments of the present disclosure, for example, an exit guidance video control and a replay control are provided on an interface for displaying the game guidance video, and the method further comprises: in response to a trigger operation for the exit guidance video control, ending a playing process of the game guidance video; or, in response to a trigger operation for the replay control, replaying the game guidance video.

According to one or more embodiments of the present disclosure, an apparatus for displaying prompt information is provided. The apparatus further comprises: a prompt content prompt module, configured for, in accordance with a detection that a to-be-displayed prompt content associated with a current live stream content is pre-stored on a resource server, displaying a prompt content request entrance on a current live stream interface; a prompt content request module, configured for, in response to a trigger instruction of the prompt content request entrance, requesting the to-be-displayed prompt content from the resource server; and a prompt content display module, configured for overlaying a view layer on the current live stream interface and displaying the to-be-displayed prompt content, wherein the to-be-displayed prompt content is a non-livestream traffic pushing content.

According to one or more embodiments of the present disclosure, the apparatus for displaying prompt information further comprises, for example, a prompt content storage module configured for: after requesting the to-be-displayed prompt content from the resource server, storing the to-be-displayed prompt content in a predetermined non-livestream traffic pushing data storage path.

According to one or more embodiments of the present disclosure, the apparatus for displaying prompt information further comprises, for example, a display parameter setting module configured for: before displaying the to-be-displayed prompt content, setting at least one parameter of a display position, a display mode, a number of display times, a display duration, or a display effect of the to-be-displayed prompt content.

According to one or more embodiments of the present disclosure, in the apparatus for displaying prompt information, for example, the prompt content display module may be configured for: displaying the to-be-displayed prompt content in a form of texts, pictures, or videos.

According to one or more embodiments of the present disclosure, in the apparatus for displaying prompt information, for example, the prompt content prompt module may be configured for: in response to a trigger operation by a user performed on any live stream game on the current live stream interface, detecting whether a game guidance video of the live stream game is pre-stored in the resource server based on an identifier of the live stream game; and in accordance with a detection that the game guidance video of the live stream game is pre-stored in the resource server, displaying a request entrance for displaying the game guidance video on the current live stream interface.

According to one or more embodiments of the present disclosure, in the apparatus for displaying prompt information, for example, the prompt content display module may further be configured for: overlaying the view layer on the current live stream interface and playing the game guidance video.

According to one or more embodiments of the present disclosure, for example, an exit guidance video control and a replay control are provided on an interface for displaying the game guidance video, in the apparatus for displaying prompt information, the prompt content display module may further be configured for: in response to a trigger operation for the exit guidance video control, ending a playing process of the game guidance video; or, in response to a trigger operation for the replay control, replaying the game guidance video.

Furthermore, while multiple operations are depicted adopting a particular order, this should not be understood as requiring that the operations be performed in the particular order shown or in a sequential order of execution. Multitasking and parallel processing may be advantageous in certain environments. Similarly, while several specific implementation details are included in the above discussion, these should not be interpreted as limiting the scope of the present disclosure. Certain features described in the context of separate embodiments may also be implemented in combination in a single embodiment. In contrast, a plurality of features described in the context of a single embodiment may also be implemented in multiple embodiments, either individually or in any suitable sub-combination.

1. A method for displaying prompt information, comprising:
in response to detecting a to-be-displayed prompt content associated with a current live stream content is pre-stored on a resource server, displaying a prompt content request entrance on a current live stream interface;
in response to a trigger instruction of the prompt content request entrance, requesting the to-be-displayed prompt content from the resource server; and
overlaying a view layer on the current live stream interface and displaying the to-be-displayed prompt content, wherein the to-be-displayed prompt content is a non-livestream traffic pushing content.

2. The method of claim 1, after requesting the to-be-displayed prompt content from the resource server, the method further comprising:
storing the to-be-displayed prompt content in a predetermined non-livestream traffic pushing data storage path.

3. The method of claim 1, before displaying the to-be-displayed prompt content, the method further comprising:
setting at least one parameter of a display position, a display mode, a number of display times, a display duration, or a display effect of the to-be-displayed prompt content.

4. The method of claim 1, wherein the displaying the to-be-displayed prompt content comprises:
displaying the to-be-displayed prompt content in a form of texts, pictures, or videos.

5. The method of claim 4, wherein the in response to detecting a to-be-displayed prompt content associated with a current live stream content is pre-stored on a resource server, displaying a prompt content request entrance on a current live stream interface comprises:
in response to a trigger operation by a user performed on any live stream game on the current live stream interface, detecting whether a game guidance video of the live stream game is pre-stored in the resource server based on an identifier of the live stream game; and
in response to detecting that the game guidance video of the live stream game is pre-stored in the resource server, displaying a request entrance for displaying the game guidance video on the current live stream interface.

6. The method of claim 5, wherein the overlaying a view layer on the current live stream interface and displaying the to-be-displayed prompt content comprises:
overlaying the view layer on the current live stream interface and playing the game guidance video.

7. The method of claim 6, wherein an exit guidance video control and a replay control are provided on an interface for displaying the game guidance video, the method further comprises:
in response to a trigger operation for the exit guidance video control, ending a playing process of the game guidance video; or, in response to a trigger operation for the replay control, replaying the game guidance video.

8-10. (canceled)

11. An electronic device, comprising:
one or more processors; and
a storage unit configured for storing one or more programs,
the one or more programs, when executed by the one or more processors, causing the one or more processors to implement a method for displaying prompt information comprising:
in response to detecting a to-be-displayed prompt content associated with a current live stream content is pre-stored on a resource server, displaying a prompt content request entrance on a current live stream interface;
in response to a trigger instruction of the prompt content request entrance, requesting the to-be-displayed prompt content from the resource server; and
overlaying a view layer on the current live stream interface and displaying the to-be-displayed prompt content, wherein the to-be-displayed prompt content is a non-livestream traffic pushing content.

12. The electronic device of claim 11, after requesting the to-be-displayed prompt content from the resource server, wherein the acts further comprises:
storing the to-be-displayed prompt content in a predetermined non-livestream traffic pushing data storage path.

13. The electronic device of claim 11, before displaying the to-be-displayed prompt content, wherein the acts further comprises:
setting at least one parameter of a display position, a display mode, a number of display times, a display duration, or a display effect of the to-be-displayed prompt content.

14. The electronic device of claim 11, wherein the displaying the to-be-displayed prompt content comprises:
displaying the to-be-displayed prompt content in a form of texts, pictures, or videos.

15. The electronic device of claim 14, wherein the in response to detecting a to-be-displayed prompt content associated with a current live stream content is pre-stored on a resource server, displaying a prompt content request entrance on a current live stream interface comprises:
in response to a trigger operation by a user performed on any live stream game on the current live stream interface, detecting whether a game guidance video of the live stream game is pre-stored in the resource server based on an identifier of the live stream game; and
in response to detecting that the game guidance video of the live stream game is pre-stored in the resource server, displaying a request entrance for displaying the game guidance video on the current live stream interface.

16. The electronic device of claim 15, wherein the overlaying a view layer on the current live stream interface and displaying the to-be-displayed prompt content comprises:
overlaying the view layer on the current live stream interface and playing the game guidance video.

17. The electronic device of claim 16, wherein an exit guidance video control and a replay control are provided on an interface for displaying the game guidance video, the method further comprises:
in response to a trigger operation for the exit guidance video control, ending a playing process of the game guidance video; or, in response to a trigger operation for the replay control, replaying the game guidance video.

18. A non-transitory storage medium comprising computer-executable instructions, the computer-executable instructions, when executed by a computer processor, being configured for performing a method for displaying prompt information comprising:
in response to detecting a to-be-displayed prompt content associated with a current live stream content is pre-stored on a resource server, displaying a prompt content request entrance on a current live stream interface;
in response to a trigger instruction of the prompt content request entrance, requesting the to-be-displayed prompt content from the resource server; and
overlaying a view layer on the current live stream interface and displaying the to-be-displayed prompt content, wherein the to-be-displayed prompt content is a non-livestream traffic pushing content.

19. The non-transitory storage medium of claim 18, after requesting the to-be-displayed prompt content from the resource server, wherein the acts further comprises:
storing the to-be-displayed prompt content in a predetermined non-livestream traffic pushing data storage path.

20. The non-transitory storage medium of claim 18, before displaying the to-be-displayed prompt content, wherein the acts further comprises:
setting at least one parameter of a display position, a display mode, a number of display times, a display duration, or a display effect of the to-be-displayed prompt content.

21. The non-transitory storage medium of claim 18, wherein the displaying the to-be-displayed prompt content comprises:
displaying the to-be-displayed prompt content in a form of texts, pictures, or videos.

22. The non-transitory storage medium of claim 21, wherein the in response to detecting a to-be-displayed prompt content associated with a current live stream content is pre-stored on a resource server, displaying a prompt content request entrance on a current live stream interface comprises:
in response to a trigger operation by a user performed on any live stream game on the current live stream interface, detecting whether a game guidance video of the live stream game is pre-stored in the resource server based on an identifier of the live stream game; and
in response to detecting that the game guidance video of the live stream game is pre-stored in the resource server, displaying a request entrance for displaying the game guidance video on the current live stream interface.

23. The non-transitory storage medium of claim 22, wherein the overlaying a view layer on the current live stream interface and displaying the to-be-displayed prompt content comprises:
overlaying the view layer on the current live stream interface and playing the game guidance video.
